(19) United States
(12) Patent Application Publication
(10) Pub. No.: US 2009/0303697 A1
(43) Pub. Date: Dec. 10, 2009

(54) OPTICAL SHEET, BACKLIGHT UNIT, AND LIQUID CRYSTAL DISPLAY

(76) Inventors: Yongsu KIM, Cheongju-si (KR); Cheol Yoon, Cheongju-si (KR)

Correspondence Address: KED & ASSOCIATES, LLP, P.O. Box 221200, Chantilly, VA, 20153-1200, US

(21) Appl. No.: 12/337,168

(22) Filed: Dec. 17, 2008

(30) Foreign Application Priority Data
Jun. 9, 2008 (KR) 10-2008-0053521

(51) Int. Cl. C09K 19/04; B32B 3/10; G09F 13/08

(52) U.S. Cl. 362/97.2; 428/172; 428/1.3

(57) ABSTRACT

An optical sheet, a backlight unit including the optical sheet, and a liquid crystal display including the backlight unit are disclosed. The optical sheet includes a base film, a base portion on the base film, and a plurality of projections on the base portion. The base portion includes a first area. The projections include a plurality of peaks and a plurality of valleys. The first area is a section including a first side adjoining to one of the valleys and a second side corresponding to a height of the base portion. A length of the first side is substantially 2 μm to 10 μm. The first area has one first bead or 2 to 5 first beads.

This application claims the benefit of Korean Patent Application No. 10-2008-0053521 filed on Jun. 9, 2008, the entire contents of which is hereby incorporated by reference.

### BACKGROUND

1. Field of the Invention

Embodiments relate to an optical sheet, a backlight unit including the optical sheet, and a liquid crystal display including the backlight unit.

2. Description of the Related Art

A display field may visually display information of various electrical signals. In the display field, various types of flat panel displays having excellent characteristics such as thin profile, lightness in weight, and low power consumption have been introduced. Additionally, flat panel displays are replacing cathode ray tubes (CRT).

Examples of flat panel displays include a liquid crystal display (LCD), a plasma display panel (PDP), a field emission display (FED), and an electroluminescence display (ELD). The liquid crystal display may be used as a display panel of notebooks, monitors of personal computers, and/or TV monitors because of a high contrast ratio and excellent display characteristics of a moving picture.

The liquid crystal display may be considered as a light receiving display. The liquid crystal display may include a liquid crystal display panel that displays an image and a backlight unit that is positioned under the liquid crystal display panel to provide the liquid crystal display panel with light.

The backlight unit may include a light source and an optical sheet. The optical sheet may include a diffusion sheet, a prism, or a protective sheet.

### SUMMARY OF THE INVENTION

Embodiments provide an optical sheet capable of improving a luminance uniformity and a diffusivity, a backlight unit including the optical sheet, and a liquid crystal display including the backlight unit.

Additional features and advantages of the exemplary embodiments of the invention will be set forth in the description which follows, and in part will be apparent from the description, or may be learned by practice of the exemplary embodiments of the invention. The objectives and other advantages of the exemplary embodiments of the invention will be realized and attained by the structure particularly pointed out in the written description and claims hereof as well as the appended drawings.

In one aspect, there is an optical sheet comprising a base film, a base portion on the base film, the base portion including a first area, and a plurality of projections on the base portion, the projections including a plurality of peaks and a plurality of valleys, wherein the first area is a section including a first side adjoining to one of the valleys and a second side corresponding to a height of the base portion, wherein a length of the first side is substantially 2 μm to 10 μm, wherein the first area has one first bead or 2 to 5 first beads.

In another aspect, there is a backlight unit comprising a light source, and an optical sheet disposed over the light source, the optical sheet including a base film, a base portion on the base film, the base portion including a first area, and a plurality of projections on the base portion, the projections including a plurality of peaks and a plurality of valleys, wherein the first area is a section including a first side adjoining to one of the valleys and a second side corresponding to a height of the base portion, wherein a length of the first side is substantially 2 μm to 10 μm, wherein the first area has one first bead or 2 to 5 first beads.

In another aspect, there is a liquid crystal display apparatus comprising a light source, an optical sheet disposed over the light source, the optical sheet including a base film, a base portion on the base film, the base portion including a first area, and a plurality of projections on the base portion, the projections including a plurality of peaks and a plurality of valleys, wherein the first area is a section including a first side adjoining to one of the valleys and a second side corresponding to a height of the base portion, wherein a length of the first side is substantially 2 μm to 10 μm, wherein the first area has one first bead or 2 to 5 first beads and a liquid crystal panel disposed on the optical sheet.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIGS. 1A and 1B illustrate an optical sheet according to a first exemplary embodiment;

FIG. 2 illustrates a section of the optical sheet according to the first exemplary embodiment;

FIG. 3 illustrates various patterns of a section of a projection according to the first exemplary embodiment;

FIGS. 4A to 4D illustrate various patterns of a side or plane of a projection according to the first exemplary embodiment;

FIGS. 5A and 5B illustrate an optical sheet according to a second exemplary embodiment;

FIGS. 6A and 6B illustrate an optical sheet according to a third exemplary embodiment;

FIGS. 7A and 7B illustrate a configuration of a backlight unit including an optical sheet according to an exemplary embodiment;

FIGS. 8A and 8B illustrate a configuration of a backlight unit according to an exemplary embodiment; and

FIGS. 9A and 9B illustrate a configuration of a liquid crystal display according to an exemplary embodiment.

### DETAILED DESCRIPTION OF THE EMBODIMENTS

Reference will now be made in detail embodiments of the invention examples of which are illustrated in the accompanying drawings.

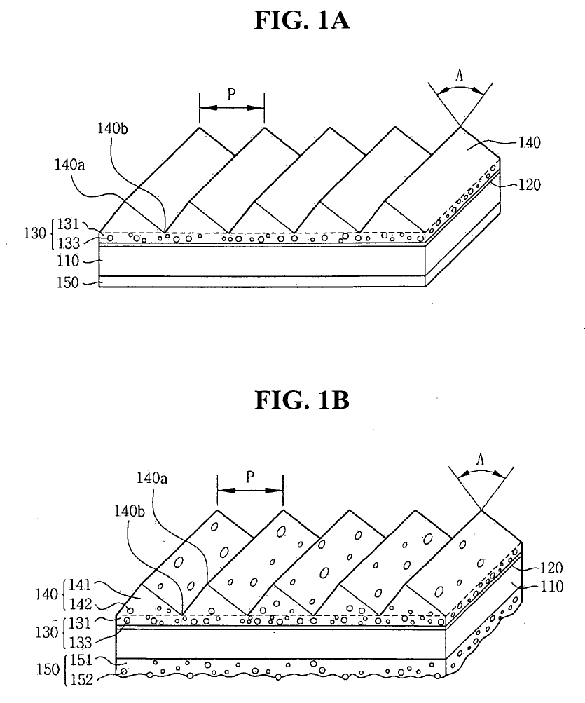

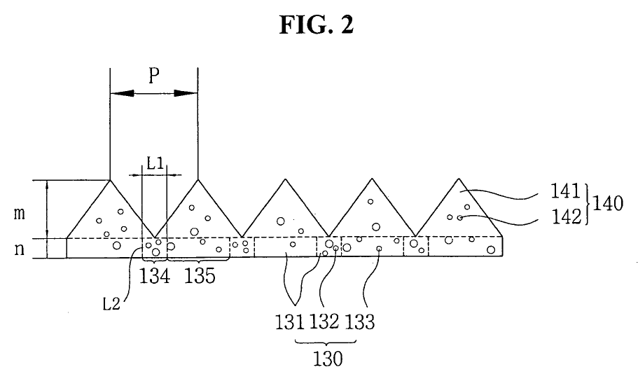

FIGS. 1A and 1B illustrate an optical sheet according to a first exemplary embodiment. FIG. 2 illustrates a section of the optical sheet according to the first exemplary embodiment.

As shown in FIGS. 1A, 1B and 2, the optical sheet according to the first exemplary embodiment includes a base film 110, a base portion 130 on the base film 110, and a plurality of projections 140 on the base portion 130. The base portion 130 includes a first area 134 having a first bead 132. The projections 140 include a plurality of peaks and a plurality of valleys.

The optical sheet according to the first exemplary embodiment may include a plurality of prism-shaped projections 140 on a base film 110 as an example of the projection 140. The prism-shaped projections 140 may include a plurality of peaks 140a and a plurality of valleys 140b. Distances P between the peaks 140a and angles A of the peaks 140a may be uniform.

A base portion 130 on the base film 110 may protect the base film 110 and transmit light coming from a light source. The base portion 130 includes a first area 134 and a second area 135. First beads 132 are formed in the first area 134, and second beads 133 are formed in the second area 135.

The first area 134 is a section of the base portion 130 in a direction of perpendicular to a longitudinal direction of the valleys 140b. The first area 134 includes a first side L1 corresponding to a virtual line adjoining to one of the valleys 140b and a second side L2 corresponding to a virtual line of a height of the base portion 130. A length of the first side L1 may be substantially 2 μm to 10 μm.

The base portion 130 and the projections 140 may include a resin. The base portion 130 may include a resin 131, a plurality of first beads 132, and a plurality of second beads 133. The projections 140 may include a resin 141 and a plurality of third beads 142.

The resins 131 and 141 may be acrylic resin. For example, the resins 131 and 141 may use acrylic-based resin, such as methyl methacrylate, ethyl methacrylate, isobutyl methacrylate, normal butyl methacrylate, normal butyl methyl methacrylate, acrylic acid, methacrylic acid, hydroxyethyl methacrylate, hydroxypropyl methacrylate, hydroxyethyl acrylate, acrylamide, methylol acrylamide, glycidyl methacrylate, ethyl acrylate, isobutyl acrylate, normal butyl acrylate, 2-ethylhexyl acrylate polymer, 2-ethylhexyl acrylate copolymer or 2-ethylhexyl acrylate terpolymer. In addition, the resins 131 and 141 may use unsaturated polyester, urethane-based resin, epoxy-based resin, and melamine-based resin. Other material may be used.

The first, second, and third beads 132, 133 and 142 may diffuse and transmit the light from the light source.

The first, second, and third beads 132, 133 and 142 may use organic and inorganic particles with high transmittance and high diffusivity. For example, the organic particles may be formed by forming acrylic-based particles, olefin-based particles such as polyethylene, polystyrene, polypropylene, and particles of copolymer and homopolymer of acrylic-based particles and olefin-based particles, and then covering the particles with a different kind of monomer. Examples of the acrylic-based material include methyl methacrylate, ethyl methacrylate, isobutyl methacrylate, normal butyl methacrylate, normal butyl methyl methacrylate, acrylic acid, methacrylic acid, hydroxyethyl methacrylate, hydroxypropyl methacrylate, hydroxyethyl acrylate, acrylamide, methylol acrylamide, glycidyl methacrylate, ethyl acrylate, isobutyl acrylate, normal butyl acrylate, 2-ethylhexyl acrylate polymer, 2-ethylhexyl acrylate copolymer or 2-ethylhexyl acrylate terpolymer.

The first beads 132 may be provided in an amount of approximately 1 to 10 parts by weight based on the resin 131 included in the first area 134 of the base portion 130. When first bead 132 content based on the resin 131 is equal to or greater than 1 part by weight, it is easy to diffuse the light from the light source using the first beads 132. When the first bead 132 content based on the resin 131 is equal to or less than 10 parts by weight, a reduction in a transmittance of the light from the light source may be prevented.

Diameters of the first beads 132 distributed inside the resin 131 may be non-uniform. The first beads 132 may be completely distributed inside the resin 131 not to project from the surface of the resin 131. The diameters of the first beads 132 may be substantially 1 μm to 3 μm. When the diameters of the first beads 132 are within the above range, the first beads 132 may efficiently diffuse and transmit the light from the light source.

The second beads 133 may be provided in an amount of approximately 1 to 10 parts by weight based on the resin 131 included in the second area 135 of the base portion 130. Diameters of the second beads 133 may be substantially 1 μm to 3 μm.

The third beads 142 may be provided in an amount of approximately 1 to 10 parts by weight based on the resin 141 of the projection 140. Diameters of the third beads 142 may be substantially 1 μm to 10 μm.

The first, second, and third beads 132, 133 and 142 may be substantially the same as one another, and the resins 131 and 141 may be substantially the same as each other. This may allow a process for forming the resins 131 and 141 on the base film 110 or a process for forming the resins 131 and 141, inside which the first, second, and third beads 132, 133 and 142 are distributed, to be more easily performed.

So far, the base portion 130 and the projection 140 are separately described in the first exemplary embodiment for the easier explanation, but the base portion 130 and the projection 140 may form an integral body.

The base film 110 may transmit the light from the light source. The base film 110 may be formed of a transparent material, such as polyethylene terephthalate (PET), polycarbonates (PC), polypropylene (PP), polyethylene (PE), polystyrene, and polyepoxy. Other materials may also be used.

The base film 110 may have a thickness of approximately 10 μm to 1,000 μm. Hence, it is easy to process the base film 110, and the base film 110 may have flexibility. When the thickness of the base film 110 is equal to or greater than 10 μm, the thin profile optical sheet may be achieved to the extent that a mechanical strength and a thermal stability of the optical sheet are secured. When the thickness of the base film 110 is equal to or less than 1,000 μm, a mechanical strength and a thermal resistance of the optical sheet may be maximumly secured to the extent that the flexibility of the optical sheet is secured.

It is described in the first exemplary embodiment that the base film 110 has a single-layered structure. However, the base film 110 may have a multi-layered structure.

The optical sheet may further include a primer layer 120 between the base film 110 and the base portion 130. The primer layer 120 may be formed on the base film 110 through a primer processing. Thus may improve an adhesive strength between the polymer film and an ultraviolet (UV) resin. Acrylic-based polymer, ester-based polymer, or urethane-based polymer may be used in the primer processing. A water-soluble polymer material may be used in the primer processing to prevent the risk of fire. The primer processing may be performed by coating the above-described polymer material on the base film.

The primer layer 120 may have a thickness of approximately 5 nm to 300 nm. When the thickness of the primer layer 120 is equal to or greater than 5 nm, a difficulty about an improvement in the adhesive strength generated when the primer layer 120 is very thin may be solved. When the thickness of the primer layer 120 is equal to or less than 300 nm, coating stains generated in the primer processing and a lump phenomenon of the polymer material may be prevented.

The following Table 1 shows transmittance characteristics and adhesive characteristics of the optical sheet depending on the thickness of the primer layer 120. In Table 1, ×, ◯, and represent bad, good, and excellent states of the characteristics, respectively.

TABLE 1

| Thickness of primer layer | Transmittance | Adhesive |
|---|---|---|
| (nm) | characteristics | characteristics |
| 3 | ⊚ | X |
| 5 | ⊚ | ◯ |
| 10 | ⊚ | ◯ |
| 30 | ⊚ | ◯ |
| 90 | ◯ | ◯ |
| 140 | ◯ | ◯ |
| 200 | ◯ | ⊚ |
| 250 | ◯ | ⊚ |
| 300 | ◯ | ⊚ |
| 400 | X | ⊚ |

As indicated in Table 1, a luminance and a color coordinate may be improved by finely adjusting the thickness of the primer layer 120.

Accordingly, when the primer processing is performed between the base film 110 and the base portion 130, the transmittance characteristics and the adhesive characteristics of the optical sheet may be improved by adjusting the thickness of the primer layer 120.

The primer layer 120 may attach the base film 110 and the base portion 130 through not a physical attachment but a chemical bonding. More specifically, the base film 110 may be formed of polymer-based material, and the base portion 130 may be formed of UV-based resin. If the base film 110 is attached to the base portion 130 through the physical attachment, it is difficult to expect the excellent adhesive strength because an adhesive surface between the base film 110 and the base portion 130 is smooth. However, when the base film 110 is attached to the base portion 130 through the chemical bonding by forming the primer layer 120 between the base film 110 and the base portion 130, the chemical bonding may obtain the adhesive strength stronger than the physical attachment, and the adhesive surface between the base film 110 and the base portion 130 may be protected.

The optical sheet according to the first exemplary embodiment may include a protective layer 150. The protective layer 150 may improve a thermal resistance of the optical sheet. The protective layer 150 may include a resin 151 and a plurality of fourth beads 152 distributed in the resin 151.

The resin 151 may be transparent acrylic-based resin with excellent thermal resistance and excellent mechanical characteristics, for example, polyacrylate or polymethylmethacrylate.

The fourth beads 152 may be formed of the same material as the resin 151 or a different material from the resin 151. The fourth beads 152 may be provided in an amount of approximately 10 to 50 parts by weight based on the resin 151. Diameters of the fourth beads 152 may be properly selected depending on the thickness of the base film 110, for example, approximately 1 μm to 10 μm. The fourth beads 152 may improve the thermal resistance of the optical sheet.

In the first exemplary embodiment, the diameters of the fourth beads 152 may be uniform or non-uniform. The fourth beads 152 may be uniformly or non-uniformly distributed in the resin 151.

The protective layer 150 may prevent the optical sheet from being deformed by the heat resulting from the light source. The optical sheet does not crease because of the protective layer 150 with excellent thermal resistance. Even if the optical sheet is deformed at a high temperature, the optical sheet may be restored to an original state at a normal temperature. The protective layer 150 may prevent the optical sheet from being damaged by an external impact or other physical impacts.

In the first exemplary embodiment, the plurality of projections 140 include the base portion 130. A height m of the projections 140 may be approximately 10 μm to 40 μm. A height n of the base portion 130 may be approximately 5% to 50% of the height m of the projections 140. The projections 140 may further improve characteristics of the base portion 130 capable of diffusing the light from the light source.

When the height n of the base portion 130 is equal to or greater than 5% of the height m of the projection 140, the base film 110 may be prevented from being damaged by a pressure in fabrication of the projection 140. When the height n of the base portion 130 is equal to or less than 50% of the height m of the projection 140, a reduction in transmittance of the light from the light source resulting from the thick base portion 130 can be prevented. Therefore, when the height n of the base portion 130 is approximately 5% to 50% of the height m of the projections 140, the transmittance of the light from the light source may be improved and haze may be properly controlled. The height n of the base portion 130 may be approximately 0.2 μm to 20 μm.

A first area 134 of the base portion 130 may have one first bead or 2 to 5 first beads. When the first area 134 adjacent to the valley under the valley has one first bead or 2 to 5 first beads, leakage of light generated in one direction may be prevented and a reduction in the transmittance may be prevented.

The following Table 2 shows light leakage prevention characteristics and transmittance characteristics of the optical sheet depending on the number of first beads 132 provided in the first area 134. In Table 2, ×, ◯, and represent bad, good, and excellent states of the characteristics, respectively.

TABLE 2

| | | Transmittance |
|---|---|---|
| Number of first beads | Light leakage prevention | characteristics |
| 0 | X | ⊚ |
| 1 | ◯ | ⊚ |
| 2 | ◯ | ⊚ |
| 3 | ⊚ | ⊚ |
| 4 | ⊚ | ◯ |
| 5 | ⊚ | ◯ |
| 6 | ⊚ | X |
| 10 | ⊚ | X |

As indicated in Table 2, the light leakage phenomenon may be prevented and the transmittance characteristics may be improved depending on the number of first beads 132 provided in the first area 134.

It is advantageous that the first area 134 of the base portion 130 may have one first bead or 2 to 5 first beads. When the first area 134 has equal to or less than 1 first bead 132, the transmittance is improved, but the light leakage phenomenon is generated. When the first area 134 has equal to or greater than 5 first beads, the light leakage phenomenon is prevented, but the transmittance is reduced.

The first area 134 is a section of the base portion 130 in a direction perpendicular to a longitudinal direction of the valley. The section includes a first side L1 adjoining to the valley and a second side L2 corresponding to the height n of the base portion 130. A length of the first side L1 may be substantially 2 μm to 10 μm.

Therefore, the first area 134 in which the length of the first side L1 is 2 μm to 10 μm has one first bead or 2 to 5 first beads, the light leakage phenomenon may be prevented and the transmittance may be improved.

The second beads 133 are distributed in a second area 135 of the base portion 130 to improve a diffusion effect of light.

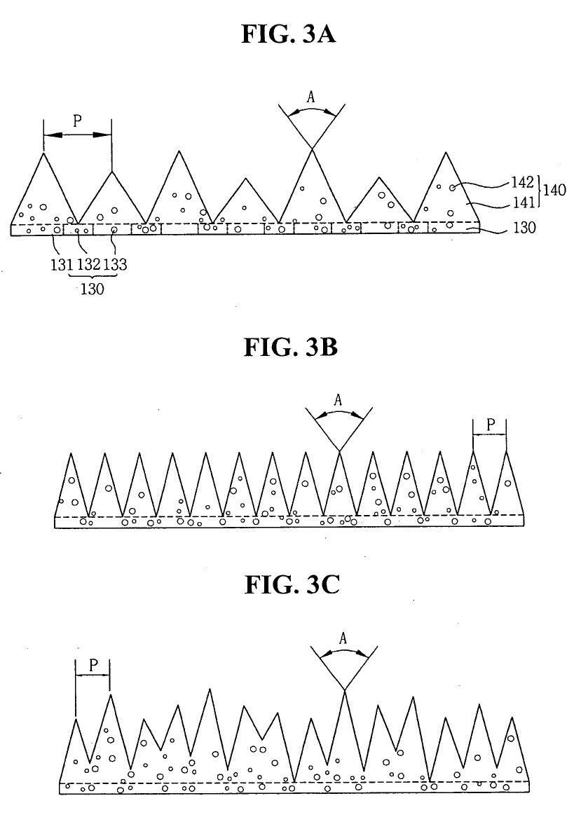

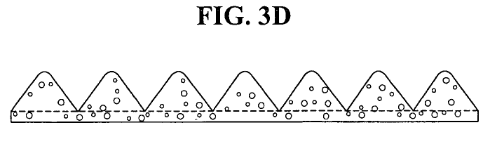

FIGS. 3A to 3D illustrate various patterns of a section of a projection according to the first exemplary embodiment.

In the projections 140 shown in FIG. 3A, distances P between peaks forming a prism shape and angles A of the peaks may be regularly non-uniform. The projections 140 shown in FIG. 3A may have a diffusion effect in which a refraction index of light coming from the base film 110 uniformly changes.

In the projections 140 shown in FIG. 3B, distances P between peaks forming a prism shape and angles A of the peaks may be relatively small. In other words, the peaks and valleys may be closely arranged. The projections 140 shown in FIG. 3B may improve characteristics in which light from base film 110 travel in a straight line.

In the projections 140 shown in FIG. 3C, peaks and valleys forming a prism shape may be formed in a random manner. The projections 140 shown in FIG. 3C may have a diffusion effect in which a refraction angle of light coming from the base film 110 is non-uniform.

The distance P between the peaks and the angle A of the peak in at least one of the projections 140 shown in FIGS. 3A to 3C may be different from the other projections 140. Hence, a shape of the valleys may change. In FIG. 3A to 3C, the distance P between the peaks may be approximately 20 μm to 60 μm, the angle A of the peak may be approximately 70° to 110°, and a height of the projections 140 may be approximately 10 μm to 40 μm. Other sizes may be used.

In the projections 140 shown in FIG. 3D, peaks and valleys forming a prism shape may be formed in not a straight-line shape but a rounding shape. The projections 140 shown in FIG. 3D may have a diffusion effect in which a refraction index of light coming from the base film 110 increases.

While FIGS. 3A to 3D illustrate various patterns of the prism-shaped section of the projection 140, the projection 140 may have various patterns of side or plane.

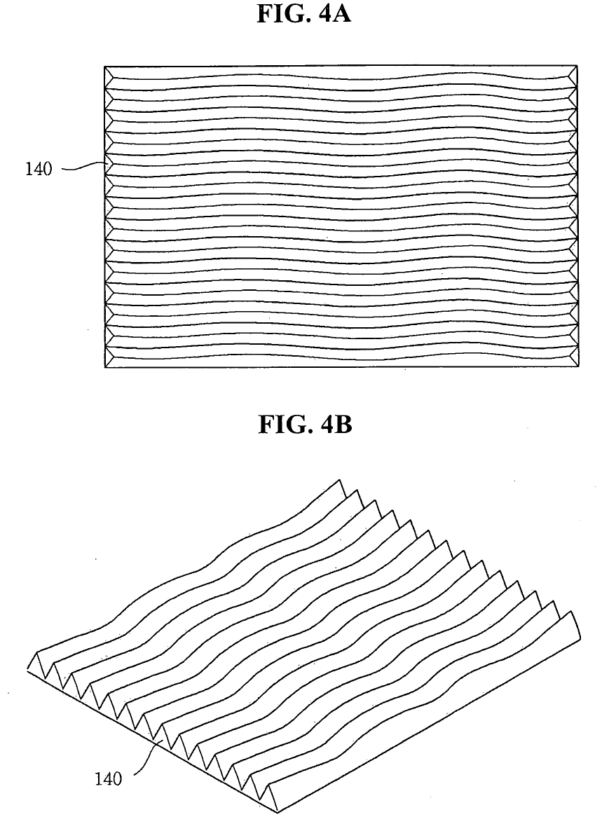

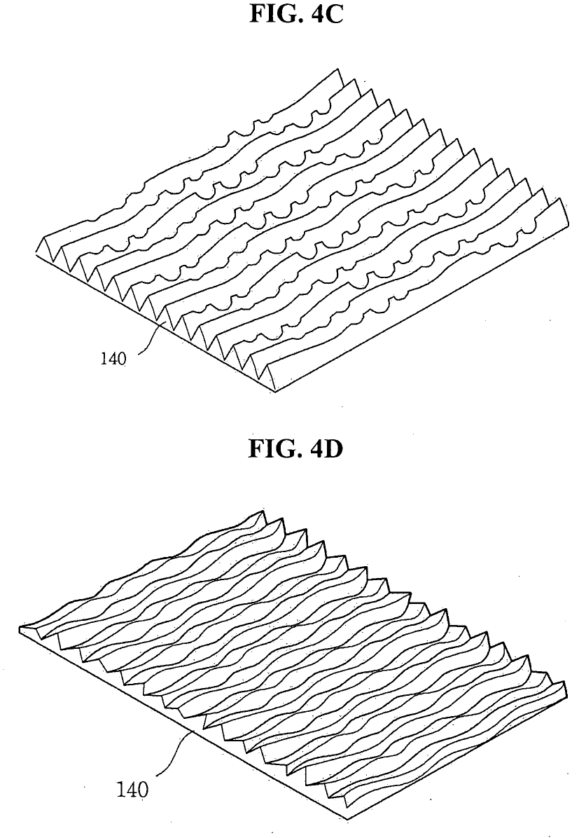

FIGS. 4A to 4D illustrate various patterns of a side or plane of the projection according to the first exemplary embodiment.

Since the optical sheet of FIGS. 4A to 4D illustrating in detail the side of the projection is similar or the same as that shown in FIGS. 1 to 3, a further description thereof may be omitted.

As shown in FIGS. 4A to 4D, peaks and valleys of the projections 140 may form continuous bending lines or meandering patterns along a longitudinal direction of the projection 140, and the continuous bending lines or meandering patterns may be uniform or non-uniform. In other words, the peaks of the projection 140 may meander in an uneven pattern (or an uneven manner). An average horizontal amplitude of the peaks may be approximately 1 μm to 20 μm. Further, the valleys of the projection 140 may meander in an uneven pattern (or an uneven manner). An average horizontal amplitude of the valleys may be approximately 1 μm to 20 μm.

A height of the peaks of the projection 140 may be measured from a bottom of the valley closest to the base film 110. The height may be different for each of the peaks. The peaks may form uniform or non-uniform bending lines and/or meandering uneven patterns. An average difference between the heights of the peaks may be approximately 1μm to 20 μm.

A backlight unit including the optical sheet according to the first exemplary embodiment described so far operates as follows.

Light produced by a light source is incident on the optical sheet. A portion of the light incident on the optical sheet collides with the beads inside the optical sheet, and a travel path of the light changes. Another portion of the light incident on the optical sheet passes through an emitting surface of the projection to travel toward a liquid crystal display panel.

The light, whose a travel path changes by colliding with the first beads, collides with the first beads adjacent to the colliding first beads, and a travel path of the light changes again. A portion of the light, whose the travel path changes twice, passes through the emitting surface of the projection to travel toward the liquid crystal display panel. Another portion of the light, whose the travel path changes twice, collides with the first beads, and a travel path of the light changes.

Finally, the light passing through the emitting surface of the projection is uniformly incident on the liquid crystal display panel.

As described above, light incident on the optical sheet is reflected several times from the plurality of first beads distributed inside the projection and is diffused while a travel path of the light changes. Therefore, the optical sheet may focus the light and improve the luminance.

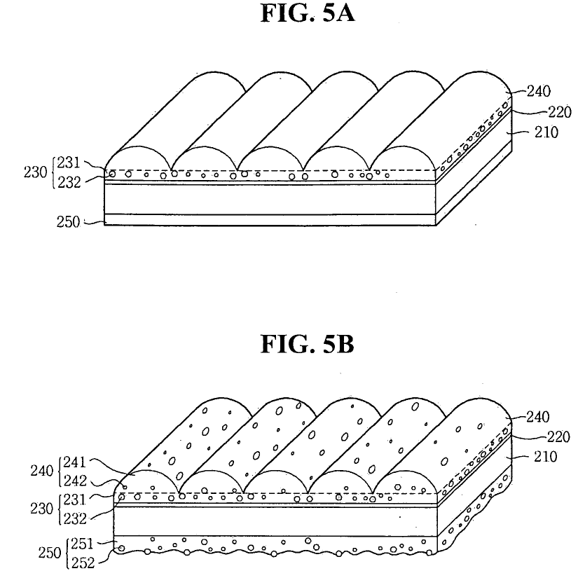

FIGS. 5A and 5B illustrate an optical sheet according to a second exemplary embodiment.

As shown in FIGS. 5A and 5B, the optical sheet according to the second exemplary embodiment includes a base film 210 and a projection 240 on the base film 210. The projection 240 includes a plurality of peaks, a plurality of valleys, and a base portion 230 under the valleys.

In the optical sheet according to the second exemplary embodiment, the projection 240 on the base film 210 may be a lenticular lens as an example of the projection. When the projection 240 includes a plurality of lenticular lenses, the hemispherical shaped lenticular lenses may be arranged adjacent to each other.

As described above with reference to FIGS. 1 to 4D, a diffusivity, a refractive index, a focusing level, etc. of the projection 240 may change depending on a pitch and a density of the lenticular lens. Since configurations of the lenticular lens-shaped projection are similar or the same as the prism-shaped projection shown in FIGS. 1 to 4D, a further description thereof may be omitted.

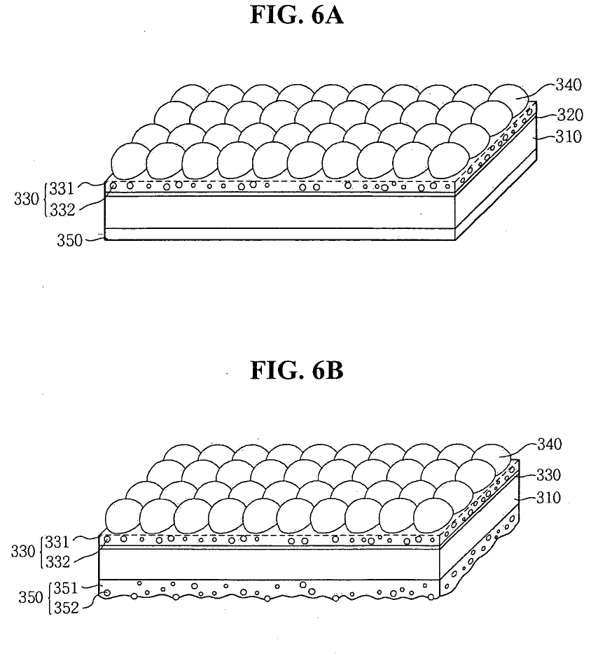

FIGS. 6A and 6B illustrate an optical sheet according to a third exemplary embodiment.

As shown in FIGS. 6A and 6B, the optical sheet according to the third exemplary embodiment includes a base film 310 and a projection 340 on the base film 310. The projection 340 includes a plurality of peaks, a plurality of valleys, and a base portion 330 under the valleys.

In the optical sheet according to the third exemplary embodiment, the projection 340 on the base film 310 may be a microlens array as an example of the projection. When the projection 340 is the microlens array, the microlenses may be non-uniformly arranged.

As described above with reference to FIGS. 1 to 4D, a diffusivity, a refractive index, a focusing level, etc. of the projection 340 may change depending on a pitch and a density of the microlenses. Since configurations of the microlens-shaped projection are similar or the same as the prism-shaped projection shown in FIGS. 1 to 4D, a further description thereof may be omitted.

A diameter of each of the microlenses on the base film 310 may be approximately 20 μm to 200 μm. The microlenses may occupy 50% to 90% of a whole area of the base film 310. Other diameters and percentages may also be used. Hence, a diffusivity of light coming from the base film 310 may be improved.

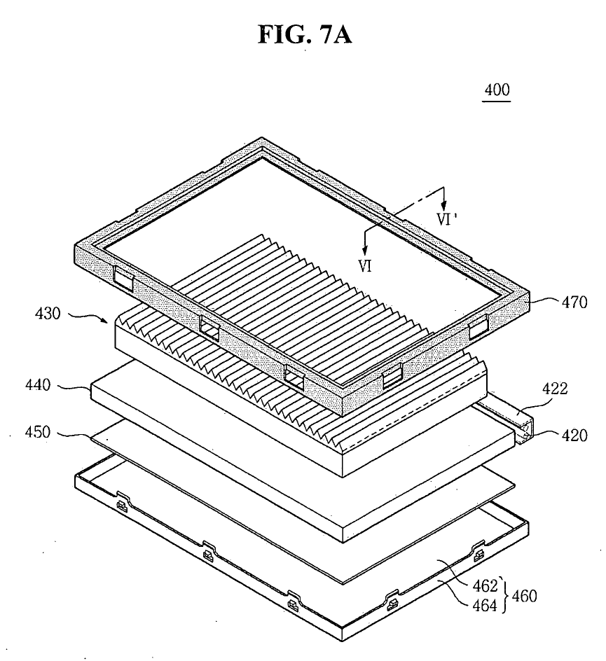

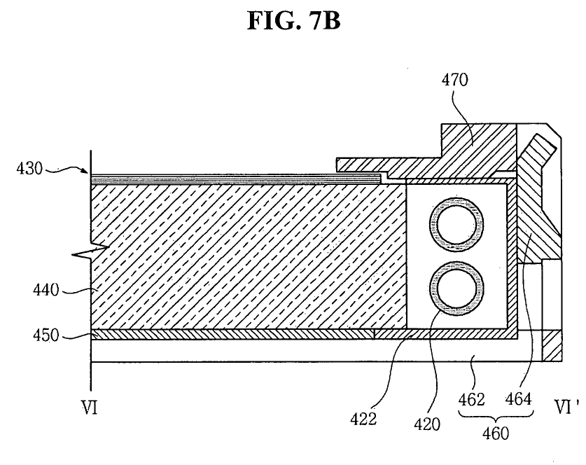

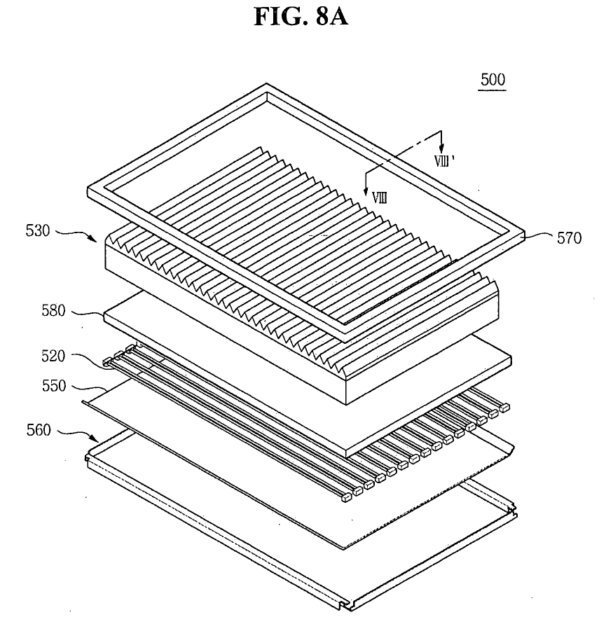

FIGS. 7A and 7B illustrate a configuration of a backlight unit including an optical sheet according to an exemplary embodiment.

FIG. 7A shows an edge type backlight unit. Since configuration of an optical sheet shown in FIGS. 7A and 7B is substantially the same as the optical sheets described above, a further description may be briefly made or may be entirely omitted.

As shown in FIGS. 7A and 7B, a backlight unit 400 may be included in a liquid crystal display and may provide light to a liquid crystal display panel included in the liquid crystal display.

The backlight unit 400 may include a light source 420 and an optical sheet 430. The backlight unit 400 may further include a light guide 440, a reflector 450 (or reflector plate), a bottom cover 460, and a mold frame 470.

The light source 420 may produce light using a drive power received from outside the light source 420 and may emit the produced light.

The light source 420 may be positioned at one side of the light guide 440 along a long axis direction of the light guide 440. The light source 420 may be positioned at both sides of the light guide 440. Light from the light source 420 may be directly incident on the light guide 440. Alternatively, the light from the light source 420 may be reflected from a light source housing 422 surrounding a portion of the light source 420, for example, surrounding about ¾ of an outer circumferential surface of the light source 420, and then the light may be incident on the light guide 440.

The light source 420 may be one of a cold cathode fluorescent lamp (CCFL), a hot cathode fluorescent lamp (HCFL), an external electrode fluorescent lamp (EEFL), and a light emitting diode (LED). Other light sources may also be used.

The optical sheet 430 may be positioned on the light guide 440. The optical sheet 430 may diffuse the light from the light source 420.

In the optical sheet 430, because the first area 134 has one first bead or 2 to 5 first beads, a transmittance and a diffusivity may be improved and a luminance may be uniform.

Although it is not shown in FIGS. 7A and 7B, a protective sheet may be further included.

The light guide 440 may face the light source 420. The light guide 440 may guide the light so as to emit the light from the light source 420 in an upward manner.

The reflector 450 may be positioned under the light guide 440. The reflector 450 may reflect the light upward. The light may come from the light source 420 and then is emitted downward via the light guide 440.

The bottom cover 460 may include a bottom portion 462 and a side portion 464 extending from the bottom portion 462 to form a recipient space. The recipient space may receive the light source 420, the optical sheet 430, the light guide 440, and the reflector 450.

The mold frame 470 may be an approximately rectangular-shaped frame. The mold frame 470 may be fastened to the bottom cover 460 from an upper side of the bottom cover 460 in a top-down manner.

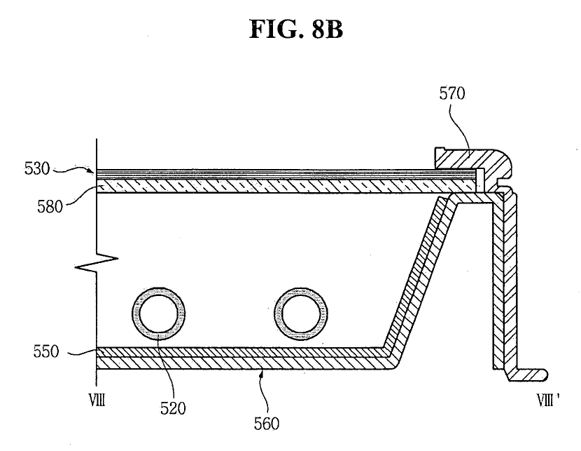

FIGS. 8A and 8B illustrate a configuration of a backlight unit according to an exemplary embodiment.

FIGS. 8A and 8B show a direct type backlight unit. Since a backlight unit 500 shown in FIGS. 8A and 8B may be substantially the same as the backlight unit shown in FIGS. 7A and 7B (except a location of a light source and changes in components depending on location of the light source), a further description may be briefly made or may be entirely omitted.

As shown in FIGS. 8A and 8B, the backlight unit 500 may be included in a liquid crystal display and may provide light to a liquid crystal display panel included in the liquid crystal display.

The backlight unit 500 may include a light source 520 and an optical sheet 530. The backlight unit 500 may further include a reflector 550 (or reflector plate), a bottom cover 560, a mold frame 570, and a diffusion plate 580 (or diffuser).

The light source 520 may be positioned under the diffusion plate 580. Therefore, light from the light source 520 may be directly incident on the diffusion plate 580.

The optical sheet 530 may be positioned on the diffusion plate 580. The optical sheet 530 may focus the light from the light source 520.

In the optical sheet 530, because the first area 134 has one first bead or 2 to 5 first bead, a transmittance and a diffusivity may be improved and a luminance may be uniform.

Although it is not shown in FIGS. 8A and 8B, a protective sheet may be further included.

The diffusion plate 580 may be positioned between the light source 520 and the optical sheet 530 and diffuse the light from the light source 520 in an upward manner. A shape of the light source 520 may not be seen from a top of the backlight unit 500 because of the diffusion plate 580 on the light source 520. The diffusion plate 580 may further diffuse the light from the light source 520.

The backlight units including the optical sheets according to the exemplary embodiment operate as follows.

Light produced by the light source is incident on the optical sheet. A portion of the light incident on the optical sheet collides with the beads inside the optical sheet, and a travel path of the light changes. Another portion of the light incident on the optical sheet passes through an emitting surface of the projection to travel toward a liquid crystal display panel.

The light, whose a travel path changes by colliding with the first beads, collides with the first beads adjacent to the colliding first beads, and a travel path of the light changes again. A portion of the light, whose the travel path changes twice, passes through the emitting surface of the projection to travel toward the liquid crystal display panel. Another portion of the light, whose the travel path changes twice, collides with the first beads, and a travel path of the light changes.

Finally, the light passing through the emitting surface of the projection is uniformly incident on the liquid crystal display panel.

As described above, light incident on the optical sheet is reflected several times from the plurality of first beads distributed inside the projection and is diffused while a travel path of the light changes. Therefore, the optical sheet may focus the light and improve the luminance.

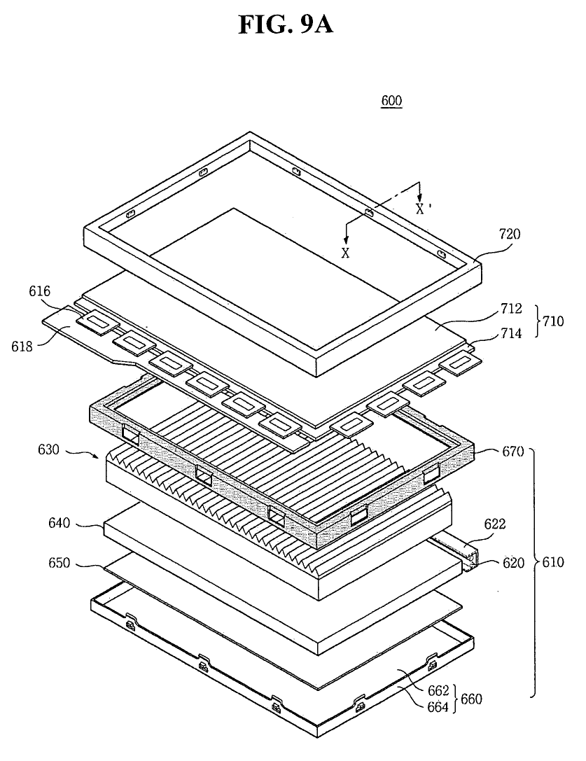

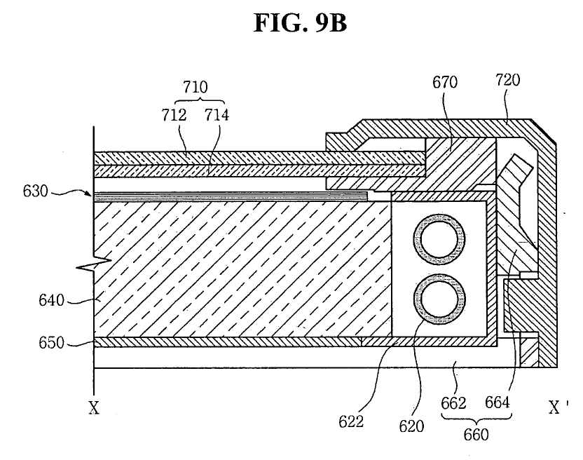

FIGS. 9A and 9B illustrate a configuration of a liquid crystal display according to an exemplary embodiment.

A liquid crystal display 600 shown in FIGS. 9A and 9B may include the backlight unit shown in FIGS. 7A and 7B. For example, the liquid crystal display 600 may include a backlight unit 610 similar to the backlight unit shown in FIGS. 8A and 8B. Since the backlight unit 610 shown in FIGS. 9A and 9B is described above with reference to FIGS. 7A and 7B, a further description thereof will be briefly made or will be entirely omitted.

As shown in FIGS. 9A and 9B, the liquid crystal display 600 may display an image using electro-optical characteristics of liquid crystals.

The liquid crystal display 600 may include the backlight unit 610 and a liquid crystal display panel 710. The backlight unit 610 may be positioned under the liquid crystal display panel 710 and may provide light to the liquid crystal display panel 710.

The backlight unit 610 may include a light source 620 and an optical sheet 630. Light from the light source 620 may be reflected from a light source housing 622. The backlight unit 610 may further include a light guide 640 (or light guide plate), a reflector 650 (or reflector plate), a bottom cover 660, and a mold frame 670.

The liquid crystal display panel 710 may be positioned on the mold frame 670. The liquid crystal display panel 710 may be fixed by a top cover 720 that is fastened to the bottom cover 660 in a top-down manner. The bottom cover 660 may include a bottom portion 662 and a side portion 664 extending from the bottom portion to form a recipient space.

The liquid crystal display panel 710 may display an image using light provided by the light source 620 of the backlight unit 610.

The liquid crystal display panel 710 may include a color filter substrate 712 and a thin film transistor substrate 714 that are opposite to each other with liquid crystals interposed between the color filter substrate 712 and the thin film transistor substrate 714.

The color filter substrate 712 may achieve colors of an image displayed on the liquid crystal display panel 710.

The color filter substrate 712 may include a color filter array of a thin film form on a substrate made of a transparent material, such as glass or plastic. For example, the color filter substrate 712 may include red, green, and blue color filters. An upper polarizing plate may be positioned on the color filter substrate 712.

The thin film transistor substrate 714 may be electrically connected to a printed circuit board 618, on which a plurality of circuit parts are mounted, through a drive film 616. The thin film transistor substrate 714 may apply a drive voltage provided by the printed circuit board 618 to the liquid crystals in response to a drive signal provided by the printed circuit board 618.

The thin film transistor substrate 714 may include a thin film transistor and a pixel electrode on another substrate made of a transparent material, such as glass or plastic. A lower polarizing plate may be positioned under the thin film transistor substrate 714.

As described above, the optical sheet, the backlight unit including the optical sheet, and the liquid crystal display including the backlight unit according to the exemplary embodiments may improve the transmittance and the diffusivity and provide uniform luminance by providing the 1 to 5 first beads in the first area of the base portion

Further, the optical sheet, the backlight unit including the optical sheet, and the liquid crystal display including the backlight unit according to the exemplary embodiments may improve the thermal resistance and the mechanical strength by further including the protective layer under the optical sheet.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An optical sheet comprising:
a base film;
a base portion on the base film, the base portion including a first area; and
a plurality of projections on the base portion, the projections including a plurality of peaks and a plurality of valleys,
wherein the first area is a section including a first side adjoining to one of the valleys and a second side corresponding to a height of the base portion,
wherein a length of the first side is substantially 2 μm to 10 μm,
wherein the first area has one first bead or 2 to 5 first beads.

2. The optical sheet of claim 1, wherein the base portion includes a plurality of second beads in a second area other than the first area.

3. The optical sheet of claim 2, wherein the plurality of projections include a plurality of third beads.

4. The optical sheet of claim 2, wherein one of the first bead, the second bead, and the third bead has a diameter of substantially 1 μm to 3 μm.

5. The optical sheet of claim 1, wherein the base film is formed of at least one selected from the group consisting of polyethylene terephthalate (PET), polycarbonate (PC), polypropylene (PP), polyethylene (PE), polystyrene, and polyepoxy.

6. The optical sheet of claim 1, wherein the plurality of projections include one of a prism, a lenticular lens, and a microlens.

7. The optical sheet of claim 1, wherein the height of the base portion is substantially 5% to 50% of that of the plurality of projections.

8. The optical sheet of claim 6, wherein the microlens on the base film occupies substantially 50% to 90% of a whole area of the base film.

9. The optical sheet of claim 1, wherein a height of at least one of the peaks varies along a longitudinal direction of the projection.

10. The optical sheet of claim 1, wherein at least one of the peaks and the valleys meanders in an uneven pattern.

11. The optical sheet of claim 1, further comprising a primer layer is disposed between the base film and the base portion.

12. The optical sheet of claim 11, wherein the primer layer includes at least one material selected from the group consisting of acrylic-based, ester-based, and urethane-based polymer materials.

13. The optical sheet of claim 11, wherein the primer layer has a thickness of substantially 5 nm to 300 nm.

14. The optical sheet of claim 1, further comprising a protective layer under the base film.

15. The optical sheet of claim 14, wherein the protective layer includes a resin and a plurality of fourth beads.

16. The optical sheet of claim 15, wherein the fourth beads have a diameter of substantially 1 μm to 10 μm.

17. The optical sheet of claim 1, wherein the base portion and the plurality of projections form an integral body.

18. A backlight unit comprising:
a light source; and
an optical sheet disposed over the light source, the optical sheet including:
a base film;
a base portion on the base film, the base portion including a first area; and
a plurality of projections on the base portion, the projections including a plurality of peaks and a plurality of valleys,
wherein the first area is a section including a first side adjoining to one of the valleys and a second side corresponding to a height of the base portion,
wherein a length of the first side is substantially 2 μm to 10 μm,
wherein the first area has one first bead or 2 to 5 first beads.

19. A liquid crystal display apparatus comprising:
a light source;
an optical sheet disposed over the light source, the optical sheet including:
a base film;
a base portion on the base film, the base portion including a first area; and
a plurality of projections on the base portion, the projections including a plurality of peaks and a plurality of valleys,
wherein the first area is a section including a first side adjoining to one of the valleys and a second side corresponding to a height of the base portion,
wherein a length of the first side is substantially 2 μm to 10 μm,
wherein the first area has one first bead or 2 to 5 first beads.
